(19) United States
(12) Patent Application Publication
(10) Pub. No.: US 2025/0313091 A1
(43) Pub. Date: Oct. 9, 2025

(54) METHODS AND SYSTEM FOR MANAGING KEY-OFF ELECTRIC LOAD

(71) Applicant: Ford Global Technologies, LLC, Dearborn, MI (US)

(72) Inventors: Stuart C. Salter, White Lake, MI (US); Justin Richard Longbourne, Stock (GB); David Celinske, Wolverine Lake, MI (US); Vyas Darshan Shenoy, Canton, MI (US); Todd Ansbacher, Westland, MI (US); William Taylor, Ypsilanti, MI (US)

(21) Appl. No.: 18/626,104

(22) Filed: Apr. 3, 2024

(51) Int. Cl. B60L 1/00

(52) U.S. Cl. CPC B60L 1/00; B60L 2210/10

(57) ABSTRACT

Systems and methods for operating a vehicle power system are described. The vehicle power system includes a lower voltage battery and a power distribution system. Power supplied to the power distribution system may be switched from one source to another source based on an estimated electrical load.

### FIELD

The present description relates to methods and a system for managing power of a vehicle after a key-off. The methods and systems may be particularly useful for electric vehicles.

### BACKGROUND AND SUMMARY

A vehicle may include alternating current (AC) and direct current (DC) power outlets that allow a user to access power that is sourced from a vehicle power source. The AC and DC power outlets may be active when the vehicle is being operated. The AC and DC power outlets may be powered via a same power source, such as a traction battery. However, the electric power that is provided by the power source may be converted by an inverter to generate AC power that is supplied to the AC power outlets and the DC power may be provided via a DC/DC converter. Since the traction battery has limited storage capacity, it may be desirable to manage electric power that is provided by the traction battery.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIG. 2 is a schematic view of an example electric power distribution system;

FIG. 3 is an example electric power management sequence according to the method of FIGS. 4 and 5; and

FIGS. 4 and 5 show a flow chart of an example method of managing power of a vehicle.

### DETAILED DESCRIPTION

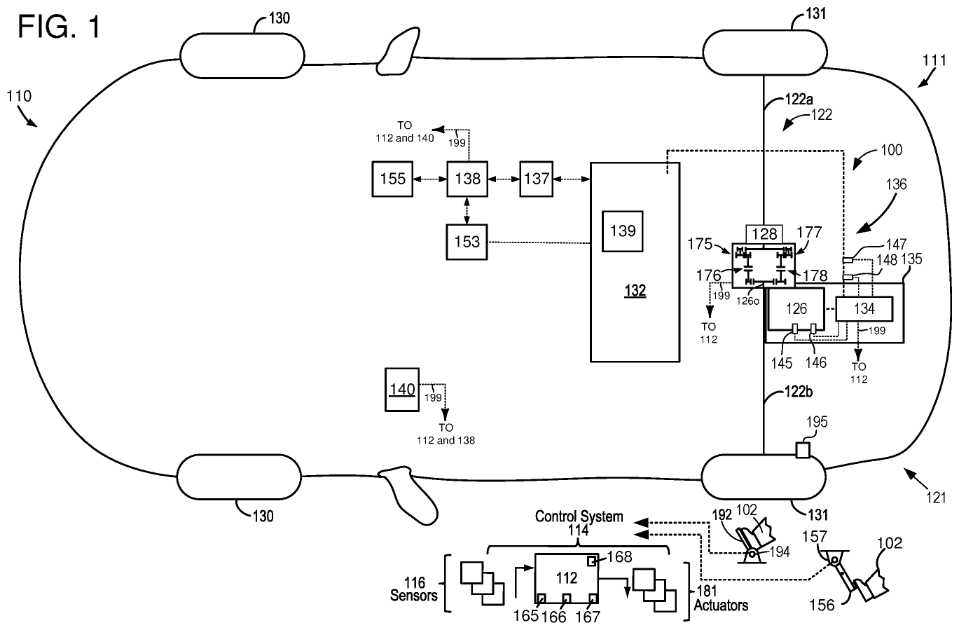

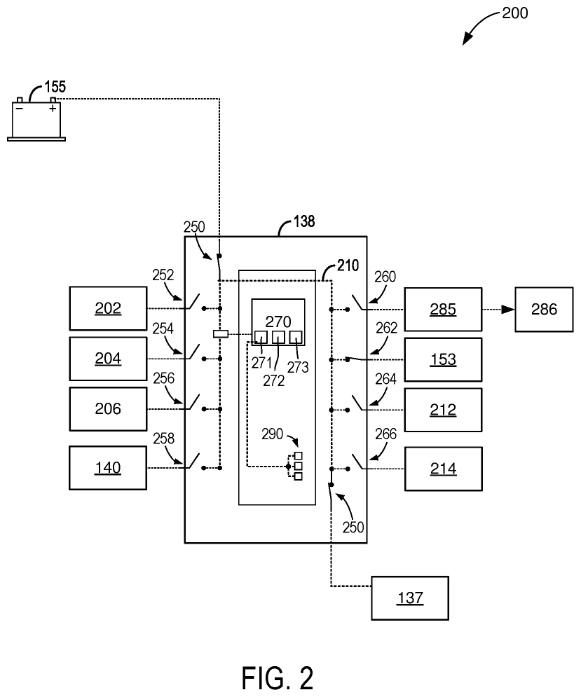

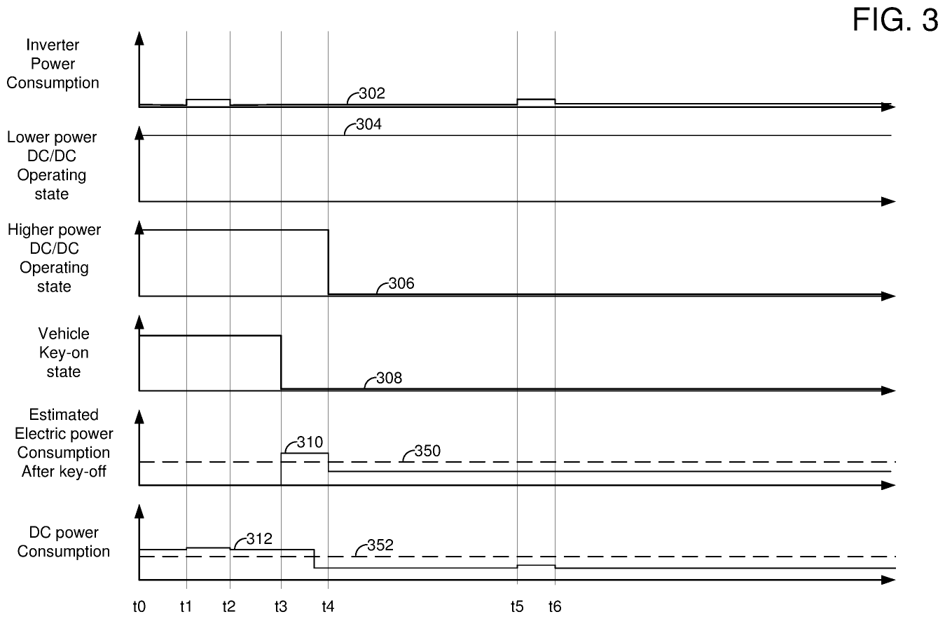

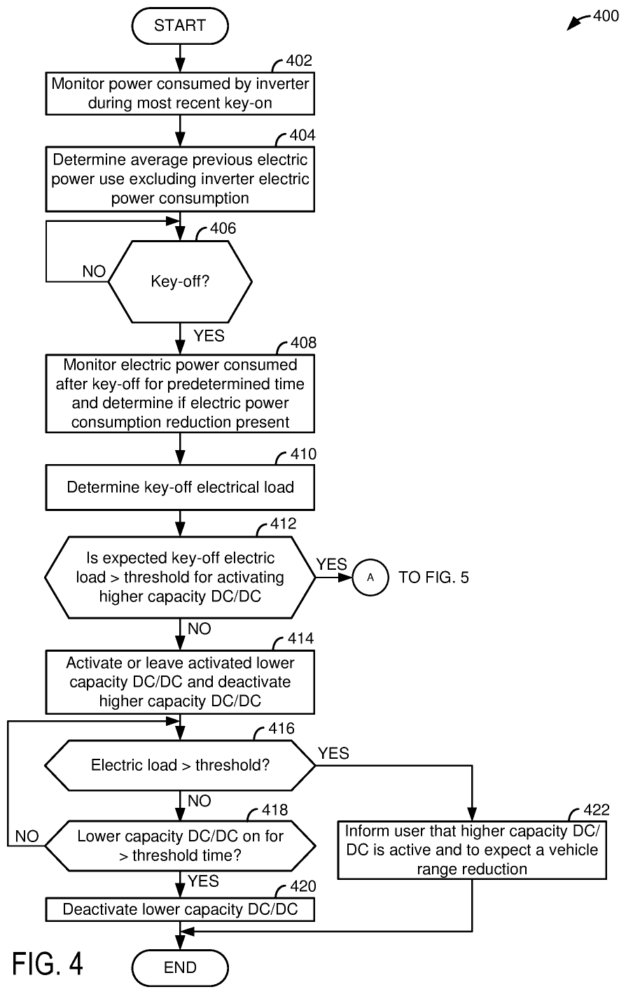

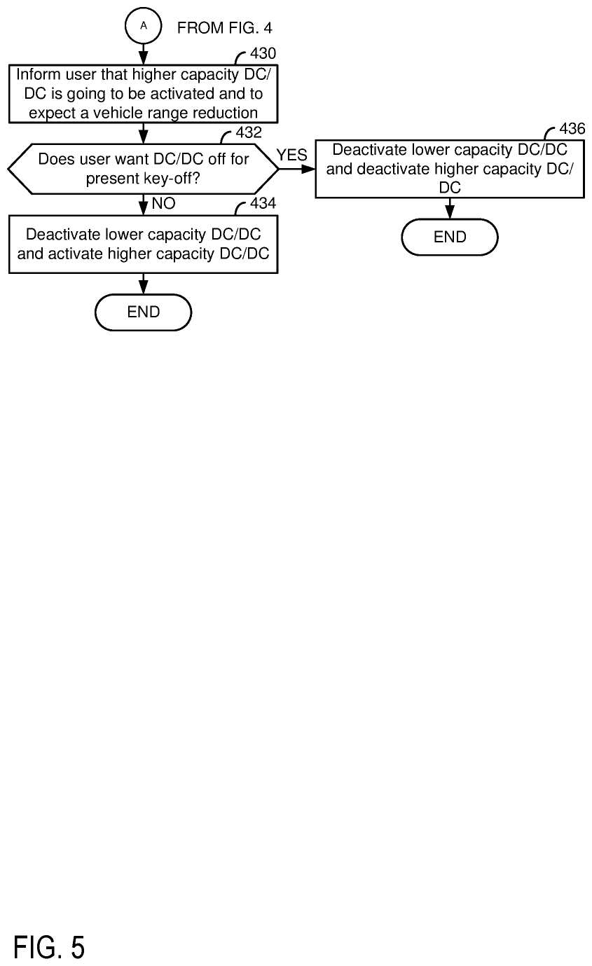

The present description is related to managing electric power of a vehicle. The vehicle may be an electric vehicle or a hybrid vehicle. The vehicle may include a traction battery and a lower voltage battery to supply electrical power throughout the vehicle. In one example, the vehicle may be an electric vehicle as shown in FIG. 1. The vehicle may include an electric power distribution system as shown in FIG. 2. Electric power from the electric power distribution system may be managed as shown in the sequence of FIG. 3 according to the method of FIGS. 4 and 5. A flow chart of a method for managing electric power of a vehicle is shown in FIGS. 4 and 5.

A vehicle may provide AC and DC power outlets for users to power devices such as computers, coolers, games, and other electric devices. It may be desirable for a user to get power from an AC and/or DC power outlet of a vehicle when the vehicle is operating or when the vehicle's propulsion system has been deactivated in response to a key-off condition (e.g., a condition where a vehicle user provides a request to deactivate the vehicle's propulsion source to prevent vehicle movement and/or conserve vehicle electric power, noting that a key may not be needed for a key-off condition). If the AC and/or DC power outlets are providing power when the vehicle is in a key-off state, the user may not realize that utilizing electric power from the AC and/or DC power outlets may reduce the vehicle's battery state of charge (SOC), thereby reducing the vehicle's available driving range. Therefore, it may be desirable to notify the user that the vehicle's available range may be reduced and manage the vehicle's electric power so that the vehicle's available driving range may remain higher.

The inventors herein have recognized the above-mentioned issues and have developed a vehicle power system, comprising: a first DC/DC converter; a second DC/DC converter, the second DC/DC converter having a higher power output capacity than the first DC/DC converter; and one or more controllers including executable instructions that cause the one or more controllers to deactivate, or keep deactivated, the second DC/DC converter, and activate, or keep activated, the first DC/DC converter after a vehicle key-off event and in response to a first operating condition, and executable instructions that cause the one or more controllers to deactivate, or keep deactivated, the first DC/DC converter, and activate, or keep activated, the second DC/DC converter after the vehicle key-off event and in response to a second operating condition.

By selecting which of two DC/DC converters is activated after a vehicle key-off condition, it may be possible to provide the technical result of lowering electric power consumption and supplying sufficient electric power to electric power consumers after a vehicle key-off event. Thus, electric power may be managed so that less power that is available for propelling a vehicle may be consumed to power accessories. Consequently, the vehicle's capacity to travel further may be at least partially maintained.

The present description may provide several advantages. In particular, the approach may lower electric power consumption after a vehicle key-off condition. Further, the approach may scale electric power output with electric power consumption to increase electric power distribution efficiency. In addition, the approach attempts to maintain a vehicle's capacity to travel further when powering accessory electrical devices.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout the FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 1260 of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle's kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle slowing pedal 156.

Electric energy storage device 132 may periodically receive electrical energy from a power source such as a stationary power grid (not shown) residing external to the vehicle (e.g., not part of the vehicle). As a non-limiting example, driveline 100 may be configured as a plug-in electric vehicle (EV), whereby electrical energy may be supplied to electric energy storage device 132 via the power grid (not shown).

Electric energy storage device 132 includes an electric energy storage device controller 139. Electric energy storage device controller 139 may provide charge balancing between energy storage element (e.g., battery cells) and communication with other vehicle controllers (e.g., controller 112). Electric energy storage device 132 is electrically coupled to a first direct current (DC)/DC converter 153 (e.g., lower capacity DC/DC converter (100 Watts)) and a second DC/DC converter 137 (e.g., higher capacity DC/DC converter (4000 Watts)). The first DC/DC converter 153 and the second DC/DC converter 137 may be bi-directional. The first DC/DC converter 153 and the second DC/DC converter 137 are electrically coupled to power distribution module 138. A lower voltage battery 155 (e.g., a 12-volt battery) is also electrically coupled to power distribution module 138.

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 and power distribution module 138 via network 199 (e.g., a controller area network (CAN) or an Ethernet network).

Referring now to FIG. 2, a detailed schematic view of an example electric power distribution system 200 including a power distribution module 138. Electrical connections between the various components shown in FIG. 2 are shown as dashed lines.

Electric power distribution module 138 includes a plurality of switches 252-266 for selectively electrically isolating electric power consumers and electric sources from DC bus 210 (e.g., a low voltage (12 volt) bus). Switches 252-266 may be solid state devices or devices that include physical contacts. Lower voltage battery 155 may be selectively coupled to DC bus 210 via contactor 250. Contactor 250 is shown in a closed state that allows electric current flow through the contactor. Electric power steering system 202 may be selectively electrically coupled to low voltage bus (e.g., metallic bars or strips that facilitate transfer of electric power) 210 via switch 252. Switch 252 is shown in an open state. Ultra-capacitor 204 may be selectively electrically coupled to DC bus 210 via switch 254. Switch 254 is shown in an open state. Electric vehicle slowing actuators 206 (e.g., caliper actuators) may be selectively electrically coupled to DC bus 210 via switch 256. Switch 256 is shown in an open state. Infotainment system 140 may be selectively electrically coupled to DC bus 210 via switch 258. Switch 258 is shown in an open state. Inverter 285 may be selectively electrically coupled to DC bus 210 via switch 260. Switch 260 is shown in an open state. Second DC/DC converter 137 may be selectively electrically coupled to DC bus 210 via contactor 280. Contactor 280 is shown in an open state. First DC/DC converter 153 may be selectively electrically coupled to DC bus 210 via switch 262. Switch 262 is shown in an open state. Vehicle lights 212 may be selectively electrically coupled to DC bus 210 via switch 264. Switch 264 is shown in an open state. Climate control system 214 may be selectively electrically coupled to DC bus 210 via switch 266. Switch 266 is shown in an open state.

The first and second DC/DC converters receive power from the traction battery and reduce the DC voltage from a higher voltage (e.g., >400 volts) to a lower voltage (e.g., a voltage between 12 and 14 volts). The DC/DC converters may supply DC power to the DC bus 210 to power lower voltage DC power consumers.

Inverter 285 may convert DC power from DC bus 210 to AC power for supplying AC power to user accessories 286 (e.g., electric coolers, fans, computers, games, etc.). The DC power may be boosted to a higher voltage (e.g., 110 volts) to generate the AC power.

Power distribution module 138 includes a controller 270 for sensing a voltage of DC bus 210 and selectively opening and closing switches 252-266 and contactors 250 and 280. Controller 270 includes a processor 273, memory 272 (e.g., read exclusive memory, random access memory, keep alive memory, etc.), and inputs and outputs 271 (e.g., analog to digital converters, digital inputs and outputs). Controller 270 may also receive input from sensors 290 via inputs and outputs 271. Sensors 290 may include but are not limited to current sensors for each device that is coupled to DC bus 210 and lines for DC voltage sensing of DC bus 210. Controller 270 may estimate electric power consumed by or provided by each device that is electrically coupled to DC bus 210.

Thus, the system of FIGS. 1 and 2 provides for a vehicle power system, comprising: a first DC/DC converter; a second DC/DC converter, the second DC/DC converter having a higher power output capacity than the first DC/DC converter; and one or more controllers including executable instructions that cause the one or more controllers to deactivate, or keep deactivated, the second DC/DC converter, and activate, or keep activated, the first DC/DC converter after a vehicle key-off event and in response to a first operating condition, and executable instructions that cause the one or more controllers to deactivate, or keep deactivated, the first DC/DC converter, and activate, or keep activated, the second DC/DC converter after the vehicle key-off event and in response to a second operating condition. In a first example, the vehicle power system includes where the first operating condition is a vehicle electric power consumption value being less than a threshold value. In a second example that may include the first example, the vehicle power system includes where the second operating condition is the vehicle electric power consumption value being greater than the threshold value. In a third example that may include one or both of the first and second examples, the vehicle power system of claim 1, where the first DC/DC converter and the second DC/DC converter are electrically coupled to a traction battery. In a fourth example that may include one more of the first through third examples, the vehicle power system includes where the first DC/DC converter and the second DC/DC converter are electrically coupled to a first voltage bus and a second voltage bus, the first voltage bus configured to transfer a lower voltage than the second voltage bus. In a fifth example that may include one or more of the first through fourth examples, the vehicle power system further comprises additional executable instructions that cause the one or more controllers to indicate a possibility of available vehicle range reduction via a human/machine interface in response to activating or keeping activated the second DC/DC converter. In a sixth example that may include one or more of the first through fifth examples, the vehicle power system further comprises additional executable instructions that cause the one or more controllers to monitor a power consumption of an inverter prior to the vehicle key-off event and determine either of the first operating condition or the second operating condition based on the power consumption of the inverter.

In addition, the system of FIGS. 1 and 2 provides for a vehicle power system, comprising: a first battery; a traction battery; a first DC/DC converter; a second DC/DC converter; an inverter; a power distribution system including a power distribution bus, the first battery selectively coupled to the power distribution bus via a first contactor, the first DC/DC converter selectively coupled to the power distribution bus via a switch, the second DC/DC converter selectively coupled to the power distribution bus via a second contactor, the inverter selectively coupled to the power distribution bus via a second switch; and one or more controllers including executable instructions that cause the one or more controllers to deactivate, or keep deactivated, the second DC/DC converter, and activate, or keep activated, the first DC/DC converter after a request to deactivate a vehicle propulsion system and in response to a first operating condition, and executable instructions that cause the one or more controllers to deactivate, or keep deactivated, the first DC/DC converter, and activate, or keep activated, the second DC/DC converter after the request to deactivate the vehicle propulsion system and in response to a second operating condition. In a first example, the vehicle power system includes where the first operating condition and the second operating condition are based on a maximum amount of power consumed by an inverter while the vehicle propulsion system is activated. In a second example that may include the first example, the vehicle power system includes where the first operating condition and the second operating condition are based on a change in power consumed by the inverter while the vehicle propulsion system is deactivated. In a third example that may include one or both of the first and second examples, the vehicle power system further comprises a human/machine interface and additional executable instructions to deactivate the second DC/DC converter in response to a user request to deactivate the second DC/DC converter. In a fourth example that may include one or more of the first through third examples, the vehicle power system further comprises a human/machine interface and additional executable instructions to indicate a reduction in a distance that a vehicle has capacity to travel via the human/machine interface in response to the second operating condition.

Referring now to FIG. 3, an example power distribution sequence according to the method of FIGS. 4 and 5 is shown. The example of FIG. 3 may be provided via the system of FIGS. 1 and 2 in cooperation with the method of FIGS. 4 and 5. The plots of FIG. 3 are aligned in time. The vertical lines represent times of interest in the sequence.

The first plot from the top of FIG. 3 is a plot of electric power consumed from a DC bus via an inverter (e.g., 285 of FIG. 2) versus time. The vertical axis represents electric power consumed by the inverter to power AC devices and the amount of electric power increases in the direction of the vertical axis arrow. The horizontal line represents time and time increases from the left side of the plot to the right side of the plot. Trace 302 represent electric power consumed by the inverter.

The second plot from the top of FIG. 3 is a plot of an operating state of a first DC/DC converter (e.g., a converter with lower power output capacity) versus time. The vertical axis represents operating state of the first DC/DC converter and the first DC/DC converter is activated (e.g., outputting a DC voltage) when trace 304 is at a higher level that is near the vertical axis arrow. The first DC/DC converter is not activated (e.g., not outputting a DC voltage) when trace 304 is at a lower level that is near the horizontal axis. The horizontal line represents time and time increases from the left side of the plot to the right side of the plot. Trace 304 represent first DC/DC converter operating status.

The third plot from the top of FIG. 3 is a plot of an operating state of a second DC/DC converter (e.g., a converter with higher power output capacity) versus time. The vertical axis represents operating state of the second DC/DC converter and the second DC/DC converter is activated (e.g., outputting a DC voltage) when trace 306 is at a higher level that is near the vertical axis arrow. The second DC/DC converter is not activated (e.g., not outputting a DC voltage) when trace 306 is at a lower level that is near the horizontal axis. The horizontal line represents time and time increases from the left side of the plot to the right side of the plot. Trace 306 represent second DC/DC converter operating status.

The fourth plot from the top of FIG. 3 is a plot of a vehicle key-on state versus time. The vertical axis represents vehicle key-on operating state and the vehicle key-on state is activated when trace 308 is at a higher level that is near the vertical axis arrow. The vehicle key-on is not activated when trace 308 is at a lower level that is near the horizontal axis. The horizontal line represents time and time increases from the left side of the plot to the right side of the plot. Trace 308 represent vehicle key-on state.

Vehicle key-on is a condition where electric power is supplied to the vehicle propulsion system and the vehicle propulsion system is prepared to propel the vehicle, but further actions such as placing the vehicle in drive and releasing wheel calipers may have to occur for the vehicle to be propelled. An actual key is not needed for vehicle key-on. Rather, a key, a phone or other remote activation device, a pushbutton, etc. may initiate a vehicle key-on condition and/or exit the vehicle from the key-on state.

The fifth plot from the top of FIG. 3 is a plot of an estimate of electric power consumed from a DC bus via all electric power consumers that are electrically coupled to the DC bus after vehicle key-off versus time. The vertical axis represents electric power consumed by all of the electric power consumers that are electrically coupled to the DC bus and the amount of electric power consumed increases in the direction of the vertical axis arrow. The horizontal line represents time and time increases from the left side of the plot to the right side of the plot. Trace 310 represents the estimated electric power consumed by all devices that are coupled to the DC bus. Trace 350 represents a maximum amount of power that the first DC/DC converter may supply to the DC bus.

The sixth plot from the top of FIG. 3 is a plot of an actual amount of electric power consumed from a DC bus via all electric power consumers that are electrically coupled to the DC bus versus time. The vertical axis represents the actual amount of electric power consumed by all of the electric power consumers that are electrically coupled to the DC bus and the amount of electric power consumed increases in the direction of the vertical axis arrow. The horizontal line represents time and time increases from the left side of the plot to the right side of the plot. Trace 312 represents the actual electric power consumed by all devices that are coupled to the DC bus. Trace 350 represents a maximum amount of power that the first DC/DC converter may supply to the DC bus.

At time t0, the vehicle is on as indicated by the vehicle key-on state and the inverter is consuming a small amount of electric power. The first DC/DC converter and the second DC/DC converter are activated. The two DC/DC converters are activated during key-on conditions so that either may supply DC power to the DC bus. However, the first DC/DC converter is configured to deliver a lower voltage 12.2 volts and the second DC/DC converter is configured to supply 12.5 volts. If the second DC/DC converter becomes degraded and if it cannot support 12.2 volts, the first DC/DC converter supplies electric power to maintain the 12.2 volts during key-on for a predetermined amount of time. The first DC/DC converter does not supply electric power to the bus when the second DC/DC converter is supplying DC power to the DC bus, but the first DC/DC converter remains activated. The estimated electric power consumed after key-off is not indicated and the actual DC power consumption from the DC bus is above threshold 352.

At time t1, the vehicle remains in the key-on state, but the amount of electric power consumed by the inverter increases due to an intermittent load increase. The operating states of the first and second DC/DC converters is unchanged and the estimated electric power consumed after key-off is not indicated. The actual DC power consumption level increases with the increase in inverter power consumption. The increase in inverter power consumption ends at time t2.

At time t3, the vehicle exits the key-on state and the estimated electric power consumption after key-off is output at a level above threshold 350. The second DC/DC converter remains activated so that the expected electric load may be supplied by the higher capacity DC/DC converter. The first DC/DC converter remains activated while waiting for a predetermined amount of time to pass since the most recent key-off (e.g., time t3). The actual DC power consumption level remains above threshold 352, but it drops to be less than threshold 352 between time t3 and time t4. The actual DC power consumption is measured and/or monitored between time t3 and time t4 (a predetermined amount of time) to allow a user to unplug a device that consumes power from the DC bus and to consider the power reduction in the estimated electric power consumption level after key-off.

At time t4, a predetermined amount of time has passed since the most recent key-off (e.g., time t3) so the change in actual DC power consumed between time t3 and time t4 is applied to adjust the estimated electric power consumed after key-off to below threshold 350. Since the estimated power consumed is now below threshold 350, the second DC/DC is deactivated and the first DC/DC converter remains activated so that DC power requirements may be met. Deactivating the second DC/DC converter reduces DC power consumption because the first DC/DC converter is more efficient to operate at power levels that are below threshold 350.

Between time t5 and time t6, the inverter power load increases as it did between time t1 and time t2, but this increase has been applied to generate the estimated electric power consumption after key-off value, which is below threshold 350. Therefore, there may be a higher level of confidence that the first DC/DC converter may meet the electric demand without having to leave the second DC/DC converter activated. Accordingly, the first DC/DC converter remains activated and it provides the increase in consumed DC power.

In this way, an electric power system may choose between two DC/DC converters which DC/DC converter to activate during key-off conditions. If the DC load increases during key-off conditions above threshold 350, the second DC/DC converter may be activated to meet the increased electric load.

Referring now to FIGS. 4 and 5, a method for managing power of a vehicle is shown. In particular, the method of FIGS. 4 and 5 may be incorporated into the system of FIGS. 1 and 2 as executable instructions stored in non-transitory memory of one or more controllers. Method 400 may be performed via the one or more controllers transforming operating states of devices and actuators in the physical world. The one or more controllers may sense vehicle operating condition via the sensors mentioned herein and adjust actuators (e.g., human/machine interfaces, switches, contactors, etc.) to manage power distribution. The vehicle may begin the method of FIGS. 4 and 5 with the first and second DC/DC converters being activated. Method 400 may be performed via controller 270, controller 112, or a combination of these and/or other controllers.

At 402, method 400 monitors and/or stores DC power amount values that are consumed via an inverter (e.g., 285 of FIG. 2) that is electrically coupled to a DC bus to controller memory. The DC power amount values are monitored and stored to controller memory while the vehicle is in a key-on state. The DC power values are monitored and stored to memory during the vehicle key-on state so that method 400 may use recent DC power amount values. The DC power amount values may be measured over a predetermined time interval and method 400 may identify a maximum DC power consumption amount (MaxDCInv) during the predetermined time interval when the vehicle is activated in a key-on state. Method 400 proceeds to 404.

At 404, method 400 determines average DC power consumed via the DC bus (e.g., 210 of FIG. 2) during a prior vehicle key-off event or condition when power is not supplied to at least one vehicle propulsion component (e.g., a traction motor) minus average DC power that was consumed by the inverter (e.g., 285 of FIG. 2) at the same time. Method 400 may retrieve the average DC power consumed via the DC bus during a prior vehicle key-off event or condition (AveKODC) minus average DC power that was consumed by the inverter from controller memory. Average DC power consumed values determined prior key-off conditions may be useful for vehicles that may deactivate some power consumers when entering the key-off state. In other examples, method 400 may determine the average DC power consumed during key-on conditions for systems that may not deactivate DC power consumers in response to the vehicle entering a key-off state. Method 400 proceeds to 406.

At 406, method 400 judges whether or not the vehicle is in a key-off condition. A key-off condition or event may be present when a user has requested that the vehicle be deactivated for the purpose of traveling, but vehicle accessories (e.g., infotainment system, power windows, windshield wipers, etc.) may remain powered. Deactivating the vehicle for the purpose of traveling may include ceasing to supply one or more propulsion devices (e.g., motor or inverter) with electrical power. The user may request key-off via an actual key, a phone or other remote radio frequency device, or a pushbutton. If method 400 judges that a key-off has been requested, the answer is yes and method 400 proceeds to 408. Otherwise, method 400 returns to 406.

At 408, method 400 begins monitoring an amount of DC electric power from the DC bus that is consumed after key-off for a predetermined amount of time. Method 400 may multiply DC current that flows through the DC bus by the voltage of the DC bus to determine the DC electric power. The DC power amount may be determined at fixed time intervals (e.g., each second) to determine if the amount of electric power consumed via the DC bus decreases following a key-off condition. The electric power that is consumed via the DC bus may decrease if a user uncouples a device that is being supplied via the DC bus. For example, a computer may be receiving power when the vehicle is activated via a DC power outlet. The user may decouple the computer after the vehicle is keyed-off to remove the computer from the vehicle. Step 408 allows the controller to determine a reduction of DC power consumption via the DC bus during this and similar situations so that the DC power consumption value may not be overestimated. Method 400 may determine an amount of power reduction by subtracting a present DC power consumption value from the DC bus to a DC power consumption value from the DC bus just prior to the vehicle entering the key-off state. The key-off power reduction amount may be determined via the following equation:

$$DCPowRed = DCPowKON - DCpowKOFF$$

where DCPowRed is the DC power consumption reduction value when the vehicle is in the key-off state, DCPowKON is the DC power consumption value when the vehicle was in a key-on state, and DCPowKOFF is the DC power consumption value when the vehicle is in the key-off state. Method 400 proceeds to 410.

At 410, method 400 estimates a key-off electric power consumed from the DC bus (e.g., the DC electric load). In one example, method 400 may estimate the key-off electric power consumed from the DC bus via the following equation:

$$ExDCKO = AveKODC + MaxDCInv - DCPowRed$$

where ExDCKO is the estimated or expected DC power consumed via the DC bus when the vehicle is in a key-off state, MaxDCInv is the maximum DC power that is expected to be consumed by the inverter (e.g., 285 of FIG. 2), and DCPowRed is the DC power consumption reduction value when the vehicle is in the key-off state. Method 400 proceeds to 412.

At 412, method 400 judges whether or not the estimated or expected DC power consumed via the DC bus is greater than a threshold amount of power for activating the second DC/DC converter. In one example, the threshold amount of power is based on a continuous power output rating for the first DC/DC converter. If method 400 judges that the expected DC power consumed via the DC bus via DC power consumers is greater than the threshold, the answer is yes and method 400 proceeds to 430. Otherwise, the answer is no and method 400 proceeds to 414.

At 414, method 400 activates or leaves activated the first DC/DC converter (e.g., lower output DC/DC converter) and deactivates the second DC/DC converter (e.g., higher output DC/DC converter). By deactivating the second DC/DC converter, power consumed from the traction battery may be reduced during key-off conditions so that a distance that the vehicle may travel under power from the traction battery may be reduced less as compared to if the second DC/DC converter were to continue operating during the key-off conditions. Additionally, a predetermined amount of time after the second DC/DC converter is deactivated, method 400 may measure and store to memory the average amount of DC power that is being consumed via the DC bus via DC power consumers in variable AveKODC. Method 400 proceeds to 414.

At 416, method 400 judges whether or not the electrical load (e.g., the amount of power consumed) from the DC bus exceeds a threshold amount of power. If so, the answer is yes and method 400 proceeds to 420.

At 418, method 400 judges whether or not the first DC/DC converter has been activated for longer than a threshold amount of time since the most recent key-off event. If so, the answer is yes and method 400 proceeds to 418. Otherwise, the answer is no and method 400 returns to 414.

At 420, method 400 deactivates the first DC/DC converter so that the first DC/DC converter may not continuously drain the traction battery up to the next key-on condition. Method 400 proceeds to exit.

At 422, method 400 provides an indication to a vehicle user that the vehicle's higher output capacity DC/DC converter is active and that there may be a reduction in the distance that the vehicle may travel due to operating the higher output DC/DC converter. Method 400 may also deactivate the higher output capacity DC/DC converter a predetermined amount of time (e.g., 5 hours) after the most recent key-off even occurred. Method 400 proceeds to exit.

At 430, method 400 provides an indication to a vehicle user that the vehicle's higher output capacity DC/DC converter is active and that there may be a reduction in the distance that the vehicle may travel due to operating the higher output DC/DC converter. Additionally, method 400 may request user input to determine whether or not the user wishes to keep the higher output DC/DC converter activated. Method 400 proceeds to 432.

At 432, method 400 judges whether or not the user wants the second or higher capacity DC/DC converter active during the present key-off. Method 400 may base this decision on user input to the human/machine interface. If method 400 judges that the user wants the higher capacity DC/DC converter deactivated during the present key-off, the answer is yes and method 400 proceeds to 436. Otherwise, the answer is no and method 400 proceeds to 434.

At 434, method 400 maintains activation or activates the second or higher capacity DC/DC converter and deactivates the first or lower capacity DC/DC converter. Method 400 may also deactivate the second DC/DC converter a predetermined amount of time (e.g., 5 hours) after the most recent key-off condition to conserve electric energy. Method 400 proceeds to exit.

At 434, method 400 deactivates the second or higher capacity DC/DC converter and deactivates the first or lower capacity DC/DC converter. The first or lower capacity DC/DC converter is deactivated since it may not have sufficient output capacity to support DC electric loads on the DC bus when the second DC/DC converter is deactivated. Method 400 proceeds to exit.

Thus, method 400 manages operation of DC/DC converters so that sufficient power may be available to DC electric loads on the DC bus while compensating for DC/DC converter efficiency and output capacity. Further, method 400 provides for user input to override automatic electric power management for situations where the user may not want to reduce a distance that the vehicle has capacity to travel according to the present level of energy stored in the traction battery.

Accordingly, the method of FIGS. 4 and 5 provides for a method managing electric power of a vehicle, comprising: via one or more controllers, activating, or maintaining activated, a first DC/DC converter, and deactivating, or maintaining deactivated, a second DC/DC converter after deactivating a propulsion system of the vehicle and in response to a first operating condition. In a first example, the method further comprises via the one or more controllers, deactivating, or maintaining deactivated, the first DC/DC converter, and activating, or maintaining activated, the second DC/DC converter after deactivating the propulsion system of the vehicle and in response to a second operating condition. In a second example that may include the first example, the method further comprises monitoring an electric power supplied via a DC bus to an inverter after deactivating the propulsion system, where the propulsion system is deactivated in response to a user request. In a third example that may include one or both of the first and second examples, the method further comprises determining an expected electrical load based on the electric power supplied via the DC bus to the inverter. In a fourth example that may include one or more of the first through third examples, the method includes where the first operating condition is a vehicle electric power consumption value being less than a threshold value. In a fifth example that may include one or more of the first through fourth examples, the method includes where the second operating condition is the vehicle electric power consumption value being greater than the threshold value. In a sixth example that may include one or more of the first through fifth examples, the method further comprises indicating a reduction in a distance that the vehicle has capacity to travel via a human/machine interface in response to the second operating condition. In a seventh example that may include one or more of the first through sixth examples, the method further comprises deactivating the second DC/DC converter in response to a threshold amount of time passing since a most recent time when the propulsion system was deactivated.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A vehicle power system, comprising:
a first DC/DC converter;
a second DC/DC converter, the second DC/DC converter having a higher power output capacity than the first DC/DC converter; and
one or more controllers including executable instructions that cause the one or more controllers to deactivate, or keep deactivated, the second DC/DC converter, and activate, or keep activated, the first DC/DC converter after a vehicle key-off event and in response to a first operating condition, and executable instructions that cause the one or more controllers to deactivate, or keep deactivated, the first DC/DC converter, and activate, or keep activated, the second DC/DC converter after the vehicle key-off event and in response to a second operating condition.

2. The vehicle power system of claim 1, where the first operating condition is a vehicle electric power consumption value being less than a threshold value.

3. The vehicle power system of claim 2, where the second operating condition is the vehicle electric power consumption value being greater than the threshold value.

4. The vehicle power system of claim 1, where the first DC/DC converter and the second DC/DC converter are electrically coupled to a traction battery.

5. The vehicle power system of claim 1, where the first DC/DC converter and the second DC/DC converter are electrically coupled to a first voltage bus and a second voltage bus, the first voltage bus configured to transfer a lower voltage than the second voltage bus.

6. The vehicle power system of claim 1, further comprising additional executable instructions that cause the one or more controllers to indicate a possibility of available vehicle range reduction via a human/machine interface in response to activating or keeping activated the second DC/DC converter.

7. The vehicle power system of claim 1, further comprising additional executable instructions that cause the one or more controllers to monitor a power consumption of an inverter prior to the vehicle key-off event and determine either of the first operating condition or the second operating condition based on the power consumption of the inverter.

8. A method managing electric power of a vehicle, comprising:
via one or more controllers, activating, or maintaining activated, a first DC/DC converter, and deactivating, or maintaining deactivated, a second DC/DC converter after deactivating a propulsion system of the vehicle and in response to a first operating condition.

9. The method of claim 8, further comprising via the one or more controllers, deactivating, or maintaining deactivated, the first DC/DC converter, and activating, or maintaining activated, the second DC/DC converter after deactivating the propulsion system of the vehicle and in response to a second operating condition.

10. The method of claim 9, further comprising monitoring an electric power amount supplied via a DC bus to an inverter after deactivating the propulsion system, where the propulsion system is deactivated in response to a user request.

11. The method of claim 10, further comprising determining an expected electrical load based on the electric power supplied via the DC bus to the inverter.

12. The method of claim 11, where the first operating condition is a vehicle electric power consumption value being less than a threshold value.

13. The method of claim 12, where the second operating condition is the vehicle electric power consumption value being greater than the threshold value.

14. The method of claim 13, further comprising indicating a reduction in a distance that the vehicle has capacity to travel via a human/machine interface in response to the second operating condition.

15. The method of claim 14, further comprising deactivating the second DC/DC converter in response to a threshold amount of time passing since a most recent time when the propulsion system was deactivated.

16. A vehicle power system, comprising:
a first battery;
a traction battery;
a first DC/DC converter;
a second DC/DC converter;
an inverter;
a power distribution system including a power distribution bus, the first battery selectively coupled to the power distribution bus via a first contactor, the first DC/DC converter selectively coupled to the power distribution bus via a switch, the second DC/DC converter selectively coupled to the power distribution bus via a second contactor, the inverter selectively coupled to the power distribution bus via a second switch; and
one or more controllers including executable instructions that cause the one or more controllers to deactivate, or keep deactivated, the second DC/DC converter, and activate, or keep activated, the first DC/DC converter after a request to deactivate a vehicle propulsion system and in response to a first operating condition, and executable instructions that cause the one or more controllers to deactivate, or keep deactivated, the first DC/DC converter, and activate, or keep activated, the second DC/DC converter after the request to deactivate the vehicle propulsion system and in response to a second operating condition.

17. The vehicle power system of claim 16, where the first operating condition and the second operating condition are based on a maximum amount of power consumed by the inverter while the vehicle propulsion system is activated.

18. The vehicle power system of claim 16, where the first operating condition and the second operating condition are based on a change in power consumed by the inverter while the vehicle propulsion system is deactivated.

19. The vehicle power system of claim 16, further comprising a human/machine interface and additional executable instructions to deactivate the second DC/DC converter in response to a user request to deactivate the second DC/DC converter.

20. The vehicle power system of claim 16, further comprising a human/machine interface and additional executable instructions to indicate a reduction in a distance that a vehicle has capacity to travel via the human/machine interface in response to the second operating condition.
